(19) United States
(12) Patent Application Publication
(10) Pub. No.: US 2006/0059298 A1
(43) Pub. Date: Mar. 16, 2006

(54) Memory module with memory devices of different capacity

(76) Inventors: Jeong-Hyeon Cho, Seongnam-Si (KR); Jung-Joon Lee, Seoul (KR); You-Keun Han, Yongin-Si (KR); Byung-Se So, Seongnam-Si (KR)

Correspondence Address: LAW OFFICE OF MONICA H CHOI, P O BOX 3424, DUBLIN, OH, 430160204, US

(21) Appl. No.: 11/102,181

(22) Filed: Apr. 8, 2005

(30) Foreign Application Priority Data
Sep. 13, 2004 (KR) 2004-73120

(51) Int. Cl. G06F 12/00

(52) U.S. Cl. 711/105; 711/170; 711/115

(57) ABSTRACT

A memory module includes a first set of at least one first type of memory device and a second set of at least one second type of memory device having a higher capacity than the first type. In addition, an additional capacity portion of the first and second sets stores information for an additional function of the memory module, and a remaining capacity portion of the first and second sets forms a rank of the memory module. The memory module avoids an asymmetric topology of signal lines and yet provides additional memory capacity.

### BACKGROUND OF THE INVENTION

This application claims priority to Korean Patent Application No. 2004-73120, filed on Sep. 13, 2004, in the Korean Intellectual Property Office, the disclosure of which is incorporated herein in its entirety by reference.

1. Field of the Invention

The present invention relates generally to memory modules, and more particularly, to a memory module with memory devices of different capacity for an additional function of the memory module.

2. Description of the Related Art

A memory module includes memory devices typically for storing data as part of a rank of the memory module. In addition, capacity of the memory devices may also be used for an additional function of the memory module. An example of such an additional function is for an error-correcting code (ECC) algorithm.

Such an error-correcting code (ECC) algorithm detects and self-corrects for an error occurring during reading/writing of data in the memory module thus providing data integrity. In particular, most high-end systems, such as servers, are adopting memory modules with an ECC algorithm (so-called ECC memory modules) for immunity to errors during data transmission.

In an ECC algorithm, parity bits are used to detect/correct such errors. Therefore, an ECC memory module uses memory capacity for storing the parity bits. To this end, a conventional ECC memory module includes additional memory devices for storing such parity bits in addition to the memory devices used for storing usual data as part of a rank of the memory module.

However, mounting additional memory devices on an ECC memory module may undesirably increase the size (hereinafter called “package size”) of the memory module. In addition, such additional memory devices may result in an increase of the load of a signal line, leading to an asymmetric topology of the signal line.

FIG. 1 is a top plan view of a conventional ECC memory module 110 and a conventional non-ECC memory module 100. Referring to FIG. 1, the ECC memory module 110 includes an additional memory device 111 to secure storage space for parity bits used in an ECC algorithm. Therefore, the package size of the ECC memory module 110 is greater than the package size of the non-ECC memory module 100.

If the memory device 111 is small, the memory device 111 may not greatly affect the package size. However, as illustrated in FIG. 1, if the memory device 111 is large, it is difficult to secure space for the memory device 111 on the ECC memory module 110. Therefore, it may be impossible to implement the ECC memory module 110.

The problem is more serious particularly when a memory module uses an earlier version of a memory device, which is relatively larger, or when a high-capacity memory module uses a high-capacity memory device for error correction. Consequently, the competitiveness of earlier products or the competitiveness of high-capacity memory modules may be compromised.

FIG. 2 illustrates the asymmetric topology of signal lines in a conventional ECC memory module. As described above, an additional memory device for storing parity bits is mounted on an ECC memory module. In this case, the load of the non-data signal line increases in proportion to the number of memory devices coupled to the non-data signal line. If the entire load of the non-data signal line is relatively low, this is not a problem.

However, if the load of the non-data signal line is very high, for example, in the case of a high-capacity memory module using a stack package, the load of the non-signal line is increased by mounting any additional memory device. Such increased load of the non-data signal line significantly limits an operating frequency of the memory module and may even make it impossible to secure a high-speed and/or high-capacity ECC memory module.

Referring to FIG. 2, the conventional ECC memory module has nine memory devices including an additional memory device (i.e., the darker shaded memory device in FIG. 2) for storing the parity bits of the ECC algorithm. Generally, data signals are directly transmitted and received through a pin of the ECC memory module to increase data transmission rates.

However, a signal line for non-data signals, such as command signals or address signals, is shared by all memory devices. In most conventional memory modules, the non-data signal line has a T-branch structure or a tree structure (as illustrated by the dark lines in FIG. 2). If nine memory devices are mounted on the ECC memory module as illustrated in FIG. 2, the fidelity of the non-data signals transmitted in both directions is reduced due to the asymmetric structure of the non-data signal line.

FIGS. 3 and 4 are schematic diagrams illustrating a topology of a non-data signal line in conventional ECC memory modules. The ECC memory module of FIG. 3 is a single rank ×8 ECC memory module, which includes eight ×8 (i.e., eight bit input) memory devices that form 1 rank (with total 64 data signals) and one additional ×8 memory device for storing the parity bits of the ECC function. The additional ×8 memory device is for the ECC function using ×8 parity bits, which amount to an eighth of all of the data signals.

Since data signal lines including signal lines for the parity bits have a point-to-point (P2P) topology, the data signal lines are not affected by the number of memory devices. However, a non-data signal line has a T-branch or tree structure. Thus, a symmetric topology is difficult to achieve for the non-data signal line unless a memory module has an even number of memory devices.

Such an asymmetric topology for the non-data signal line worsens signal distortion when a signal is transmitted/reflected, thereby reducing the fidelity of the signal line. The reduced fidelity of the signal line has a major effect in the case of a high-speed memory module.

Referring to FIG. 4, a conventional ECC memory module includes a dummy capacitor to correct for such an asymmetric topology of the non-data signal line. Referring to FIG. 4, the dummy capacitor is installed at the end of the non-data signal line opposite to the end having the additional memory device for storing the parity bits. The dummy capacitor has a load that is similar to such an additional memory device.

However, while the dummy capacitor may correct for the asymmetric topology, the dummy capacitor increases the load of the non-data signal line. In addition, when the load of the signal line is already high, the dummy capacitor cannot be used.

### SUMMARY OF THE INVENTION

Accordingly, the present invention avoids an asymmetric topology of a signal line and yet provides additional memory capacity in a memory module.

In one aspect of the present invention, a memory module includes a first set of at least one first type of memory device and a second set of at least one second type of memory device having a higher capacity than the first type. In addition, an additional capacity portion of the first and second sets stores information for an additional function of the memory module, and a remaining capacity portion of the first and second sets forms a rank of the memory module.

In one embodiment of the present invention, a total number of the memory devices in the first and second sets is an even number. In that case, a non-data signal line coupled to the memory devices of the first and second sets has a T-branch topology with equal numbers of the memory devices to each side of the T-branch.

In another embodiment of the present invention, the memory devices of the first and second sets are all disposed on one side of the memory module with the remaining capacity portion of the first and second sets forming a single rank.

In an alternative embodiment of the present invention, the memory devices of the first and second sets are disposed on two sides of the memory module with the remaining capacity portion of the first and second sets forming double ranks.

In a further embodiment of the present invention, the memory devices of the first and second sets are disposed on two sides of the memory module with the remaining capacity portion of the first and second sets forming a single rank.

In an example embodiment of the present invention, the additional capacity portion is from only the second set. Alternatively, the additional capacity portion is from only the first set.

In another embodiment of the present invention, the second type of memory device has twice a density and twice a bit organization the first type of memory device.

In a further embodiment of the present invention, the first type of memory device and the second type of memory device have same address mapping. Alternatively, the memory module includes a presence detector that stores information regarding different address mappings of the first and second types of memory devices.

In another embodiment of the present invention, an advanced memory buffer device is disposed on a first side of the memory module, and no memory device is disposed on a second side of the memory module opposite the advanced memory buffer device.

In a further embodiment of the present invention, a respective interposer is disposed on the memory module for holding each of the second type of memory device.

The present invention may be used to particular advantage when the additional capacity portion stores parity bits for an error-correcting code (ECC) algorithm. However, the present invention may also be used for equalizing loads toward multiple directions of a non-data signal line when the additional capacity portion stores information for any other type of additional function of the memory module.

### BRIEF DESCRIPTION OF THE DRAWINGS

The above and other features and advantages of the present invention will become more apparent when described in detailed exemplary embodiments thereof with reference to the attached drawings in which:

FIG. 1 is a top plan view of a conventional error-correcting code (ECC) memory module and a conventional non-ECC memory module;

FIG. 2 shows an asymmetric topology of a non-data signal line in a conventional ECC memory module;

FIG. 3 shows a block diagram with an asymmetric non-data signal line in a conventional ECC memory module;

FIG. 4 shows a block diagram with a symmetric non-data signal line using a dummy capacitor in a conventional ECC memory module;

FIG. 5 shows an ECC memory module with symmetric non-data signal lines according to a first embodiment of the present invention;

FIG. 6 shows an ECC memory module with symmetric non-data signal lines according to a second embodiment of the present invention;

FIG. 7 shows an ECC memory module with symmetric non-data signal lines according to a third embodiment of the present invention;

FIG. 8 shows an ECC memory module with symmetric non-data signal lines according to a fourth embodiment of the present invention;

FIG. 9 shows an ECC memory module having memory devices with different address mappings according to an embodiment of the present invention;

FIG. 10A shows an AMB memory module with memory devices mounted on an opposite side of an AMB device, according to an embodiment of the present invention;

FIG. 10B shows an AMB memory module without memory devices mounted on an opposite side of the AMB device, according to an embodiment of the present invention; and

FIG. 11 shows an ECC memory module having an interposer with a larger memory device mounted thereon, according to an embodiment of the present invention.

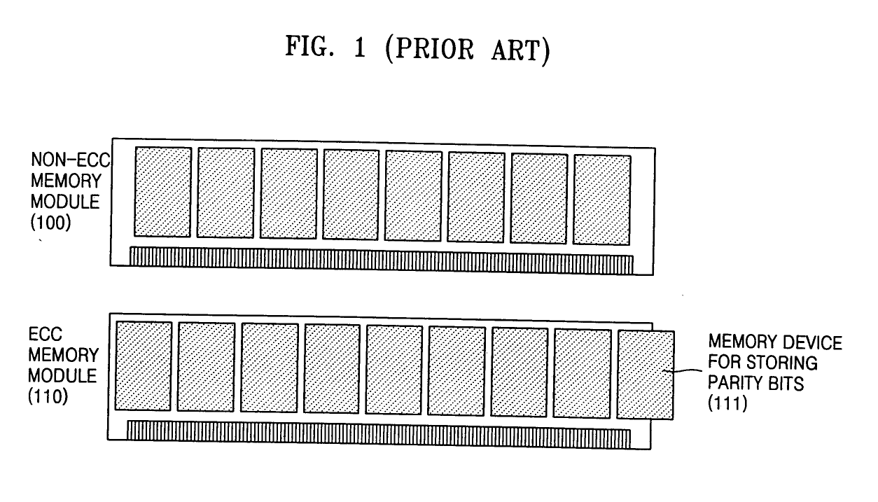

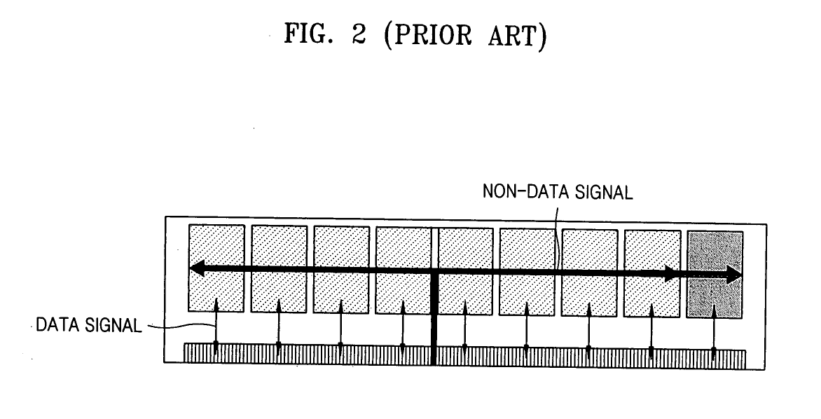

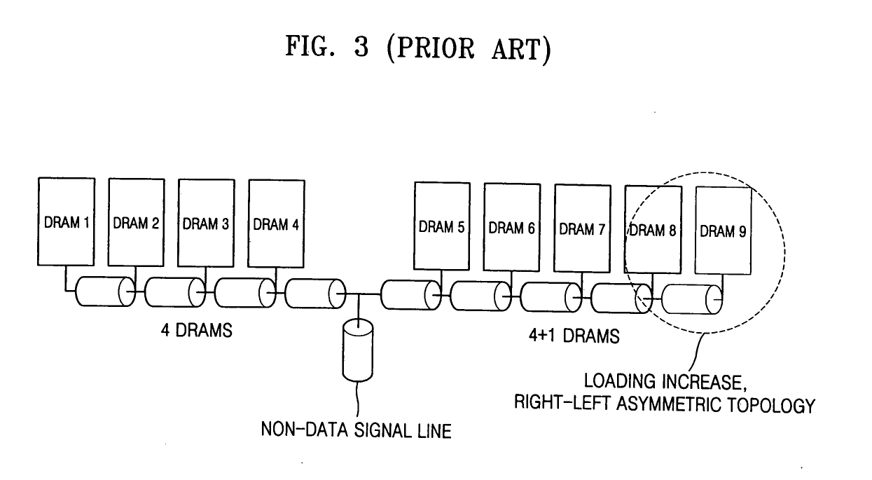

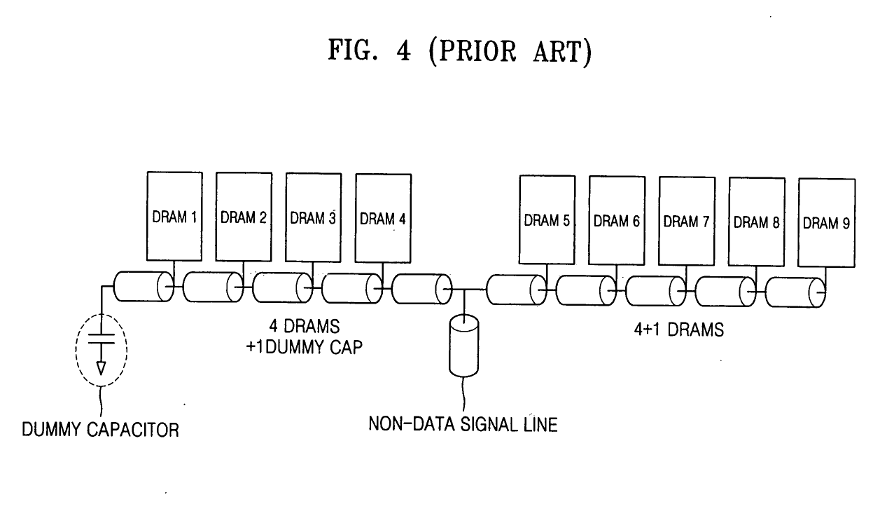

The figures referred to herein are drawn for clarity of illustration and are not necessarily drawn to scale. Elements having the same reference number in FIGS. 1, 2, 3, 4, 5, 6, 7, 8, 9, 10A, 10B, and 11 refer to elements having similar structure and/or function.

### DETAILED DESCRIPTION OF THE INVENTION

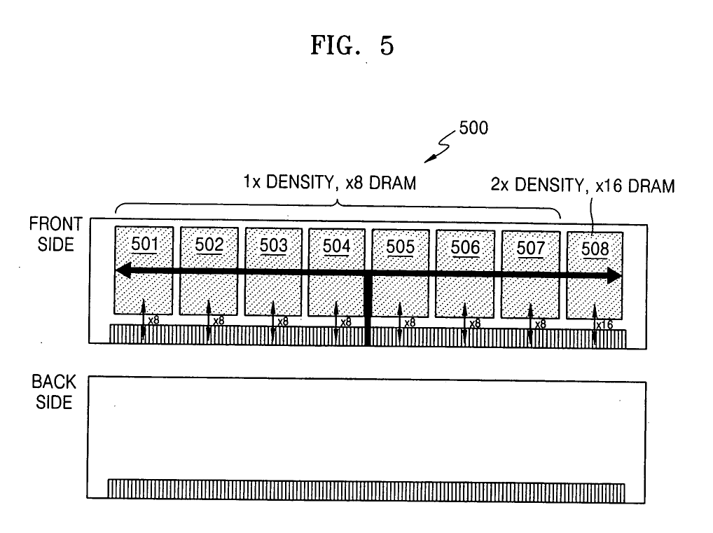

FIG. 5 shows an error-correcting code (ECC) memory module 500 according to a first embodiment of the present invention. The memory module 500 is a single rank ×8 ECC memory module with one rank having 64 data signal lines.

The ECC memory module 500 includes eight memory devices 501, 502, 503, 504, 505, 506, 507, and 508. Of the eight memory devices 501 through 508, each of the seven memory devices 501 through 507 is a ×8 (i.e., having 8 input signal lines) memory device having a 1× density, and the remaining one memory device 508 is a ×16 (i.e., having 16 input signal lines) memory device having a 2× density. Thus, the one memory device 508 has twice the data capacity and bit organization of each of the other seven memory devices 501 through 507.

The one memory device 508 is used as an ×8 memory device for forming a rank of the memory module 500, and is also used as an ×8 memory device for storing parity bits of the ECC function. A first portion of the one memory device 508 is an additional capacity portion for storing information for carrying out the ECC function. The other seven memory devices 501 through 507 and a second portion of the one memory device 508 comprise a remaining capacity portion forming a rank of the memory module 500.

However, the ×16 memory device 508 does not necessarily have to store the parity bits of the ECC function. For example, the ×16 memory device 508 may function as two ×8 memory devices for forming the rank, and one of the memory devices 501 through 507 may store the parity bits of the ECC function.

In FIG. 5, data signal lines including those for parity bit signals and non-data signal lines are configured in a similar manner as a conventional memory module. In other words, the data signal lines have a point-to-point (P2P) topology, and the non-data signal lines have a multi-drop T-branch topology (as illustrated by dark signal lines in FIG. 5).

In FIG. 5, only the number of P2P signal lines, which are the data signal lines, is increased which is easily accommodated in a memory module. Additionally in FIG. 5, with increased capacity of the one memory device 508, no more memory devices are mounted on the ECC memory module 500 compared with a non-ECC memory module. Accordingly, the ECC memory module 500 does not have a significantly increased package size and does not have asymmetric loads of the non-data signal lines.

Referring to FIG. 5, the non-data signal lines are formed in the T-branch structure branching from a point between the center memory devices 504 and 505. Thus, four memory devices are disposed on each of the right and left sides of the point where the non-data signal lines branch, thereby maintaining right-left symmetry and signal fidelity of the non-data signal lines.

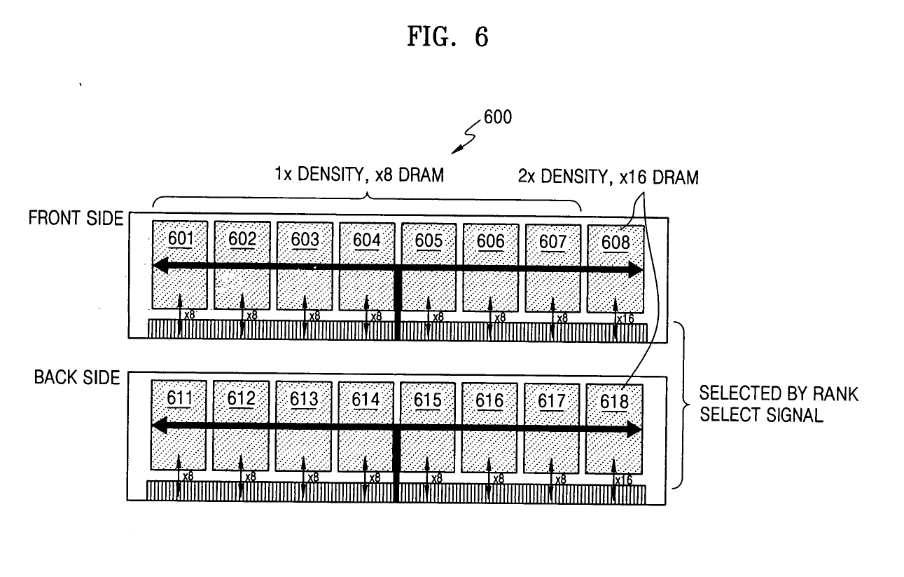

FIG. 6 shows an ECC memory module 600 according to a second embodiment of the present invention. The memory module 600 is a double rank (i.e., having two ranks) ×8 ECC memory module with one rank having 64 data signal lines. The ECC memory module 600 includes sixteen memory devices 601 through 608 and 611 through 618.

Of the sixteen memory devices 601 through 608 and 611 through 618, each of the fourteen memory devices 601 through 607 and 611 through 617 is an ×8 memory device having a 1× density, and each of the remaining two memory devices 608 and 618 is an ×16 memory device having a 2× density. Thus, each of the memory devices 608 and 618 has twice the data capacity and bit organization of each of the other fourteen memory devices 601 through 607 and 611 through 617.

The memory device 608 is used as an ×8 memory device for forming a first rank of the memory module 600, and is also used as an ×8 memory device for storing parity bits of the ECC function. A portion of the memory device 608 is an additional capacity portion for storing information for carrying out the ECC function. The other seven memory devices 601 through 607 and another portion of the memory device 608 comprise a remaining capacity portion forming the first rank of the memory module 600.

The memory device 618 is used as an ×8 memory device for forming a second rank of the memory module 600, and is also used as an ×8 memory device for storing parity bits of the ECC function. A portion of the memory device 618 is an additional capacity portion for storing information for carrying out the ECC function. The other seven memory devices 611 through 617 and another portion of the memory device 618 comprise a remaining capacity portion forming the second rank of the memory module 600.

In another embodiment of the present invention, the ×16 bit memory device 608 may function as two ×8 memory devices for forming the first rank and one of the other ×8 memory devices 601 through 607 may store the parity bits of the ECC function. In addition, the ×16 memory device 618 may function as two ×8 memory devices for forming the second rank and one of the other ×8 memory devices 611 through 617 may store the parity bits of the ECC function.

In FIG. 6, a rank select signal selects between access to one of the first and second ranks on the front and back sides of the ECC memory module 600.

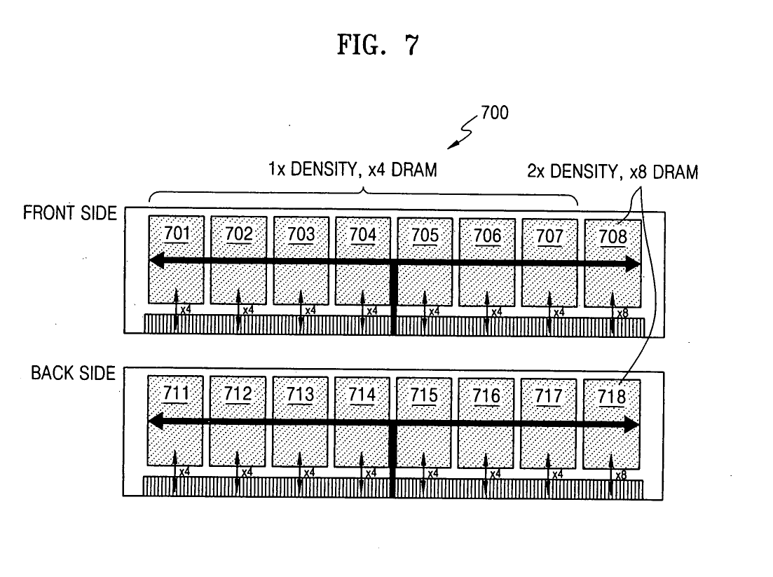

FIG. 7 shows an ECC memory module 700 according to a third embodiment of the present invention. The memory module 700 is a single rank ×4 ECC memory module with one rank having 64 data signal lines. The ECC memory module 700 includes sixteen memory devices 701 through 708 and 711 through 718.

Each of the fourteen memory devices 701 through 707 and 711 through 717 is an ×4 memory device having a 1× density, and each of the remaining two memory devices 708 and 718 is an ×8 memory device having a 2× density. Thus, portions of the memory devices 708 and 718 form an additional capacity portion for storing information for carrying out the ECC function. The other memory devices 701 through 707 and 711 through 717 and portions of the memory devices 708 and 718 comprise a remaining capacity portion forming a rank of the memory module 700.

In another embodiment of the present invention, the two ×8 bit memory devices 708 and 718 of the ECC memory module 700 may function as four ×4 memory devices for forming the rank of the memory module 700. In that case, two of the ×4 memory devices 701 through 707 and 711 through 717 provide the ECC function.

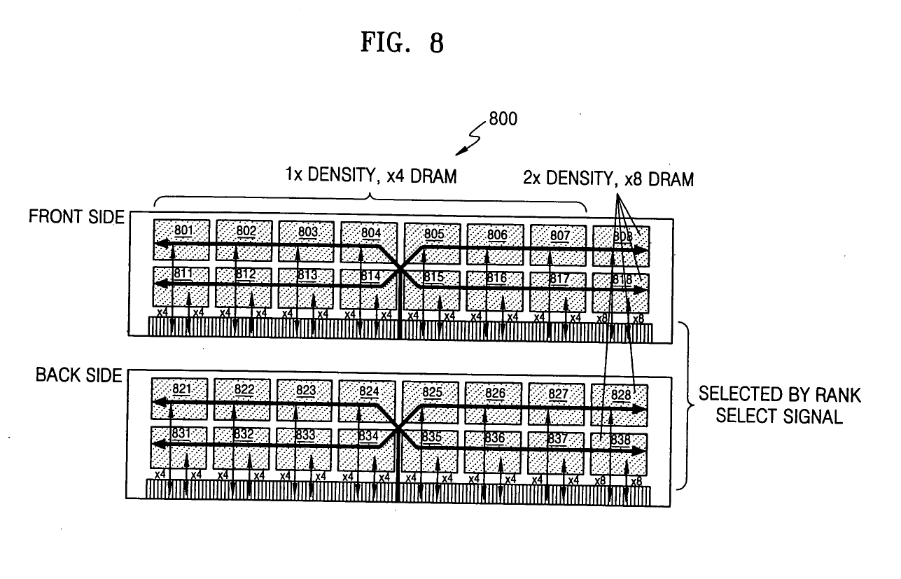

FIG. 8 illustrates an ECC memory module 800 according to a fourth embodiment of the present invention. The memory module 800 is a double rank ×4 ECC memory module with one rank having 64 data signal lines. The ECC memory module 800 includes 32 memory devices 801 through 808, 811 through 818, 821 through 828, and 831 through 838.

Of the 32 devices 801 through 808, 811 through 818, 821 through 828, and 831 through 838, each of the 28 memory devices 801 through 807, 811 through 817, 821 through 827, and 831 through 837 is a ×4 memory device having a 1× density, and each of the remaining four memory devices 808, 818, 828, and 838 is a ×8 memory device having a 2× density. Thus, each of the memory devices 808, 818, 828, and 838 has twice the data capacity and bit organization of each of the other memory devices 801 through 807, 811 through 817, 821 through 827, and 831 through 837.

The ×8 bit memory devices 808 and 818 are each used as a ×4 memory device for forming a first rank of the memory module 800, and are also each used as a ×4 memory device for storing parity bits of the ECC function. Portions of the memory devices 808 and 818 form an additional capacity portion for storing information for carrying out the ECC function. The other memory devices 801 through 807 and 811 through 817 and portions of the memory devices 808 and 818 comprise a remaining capacity portion forming the first rank of the memory module 800.

The ×8 bit memory devices 828 and 838 are each used as a ×4 memory device for forming a second rank of the memory module 800, and are also each used as a ×4 memory device for storing parity bits of the ECC function. Portions of the memory devices 828 and 838 form an additional capacity portion for storing information for carrying out the ECC function. The other memory devices 821 through 827 and 831 through 837 and portions of the memory devices 828 and 838 comprise a remaining capacity portion forming the second rank of the memory module 800.

In another embodiment of the present invention, each of the two ×8 bit memory devices 808 and 818 functions as two ×4 memory devices for forming the first rank. In that case, two of the ×4 memory devices 801 through 807 and 811 through 817 provide the ECC function. In addition, each of the two ×8 memory devices 828 and 838 on the back side functions as two ×4 memory devices for forming the second rank. In that case, two of the ×4 memory devices 821 through 827 and 831 through 837 provide the ECC function.

In FIG. 8, a rank select signal selects between access to one of the first and second ranks on the front and back sides of the ECC memory module 800.

In the embodiments described above, the way in which the memory devices, having different data capacity and bit organization, share non-data signal lines may be a problem when such memory devices use different address mapping.

In one embodiment of the present invention, each of the memory devices on a memory module 500, 600, 700, or 800 have the same address mapping. In this case, there is no problem with sharing the same non-data signal lines. For example, since a 512 MB ×16 memory device has the same address mapping as a 256 MB ×8 memory device, the 512 MB ×16 memory device and the 256 MB ×8 memory device are used in the same ECC memory module without any problem.

In another embodiment of the present invention, a second type of memory device has double the capacity and bit organization of a first type of memory device, and such memory devices have different address mappings. In that case, a mechanism is desired for such memory devices to share the non-data signal lines. For example, different address mappings are used for a 1 Gbit ×16 memory device and a 512 Mbit ×8 memory device.

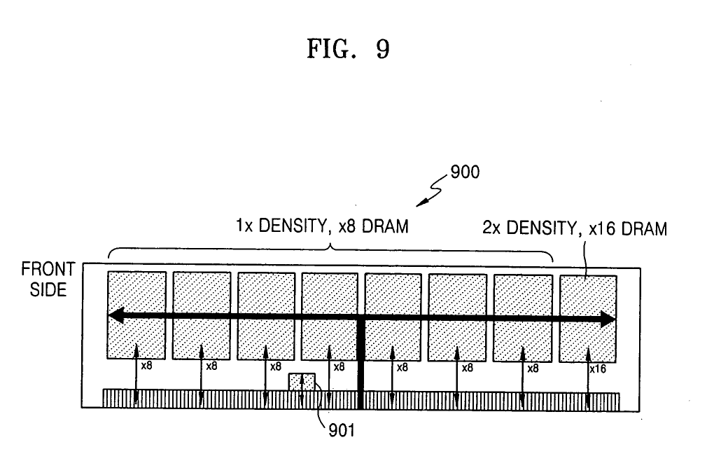

FIG. 9 illustrates an ECC memory module 900 including memory devices using different address mappings according to an embodiment of the present invention. Referring to FIG. 9, the ECC memory module 900 stores information regarding address mappings of memory devices in a presence detector 901, for example, a parallel-presence detect (PPD) or a serial-presence detect (SPD), to identify the configuration of the ECC memory module 900.

In other words, the presence detector 901 stores information needed to identify the ECC memory module 900 and transmits the information to a memory controller in a computer. The memory controller transmits information regarding the memory devices of the ECC memory module 900 according to the maximum number of row addresses of the memory devices. One of the memory devices having the maximum number of row addresses receives all signals from the memory controller, and a memory device having less row addresses receives only such a lower number of row address signals.

In addition, when transmitting a read/write command, the memory controller transmits information according to the maximum number of column addresses of the memory devices. One of the memory devices having the maximum number of column addresses receives all signals from the memory controller, and a memory device having less column addresses receives only such a lower number of column address signals.

In other words, the memory controller inputs a command signal based on the maximum number of column addresses and the maximum number of row addresses using information for identifying the memory devices included in the ECC memory module 900. Thus, the problem of sharing the non-data signal lines among memory devices with different address mappings is easily solved.

In an advanced memory buffer (AMB) DRAM, an AMB device is mounted on the center of a memory module, taking up space for the memory devices. The AMB device is mounted on a first side of the memory module, and memory devices are mounted on a second side of the memory module opposite the AMB device. However, since ball-out configurations of the AMB device and the memory devices are different, it is difficult to mount the memory devices opposite the AMB device.

In other words, the ball-out configuration of the AMB device should be designed to coincide with the ball-out configuration of the memory devices. Thus, the design of the AMB device may need to be changed according to the design of the memory device.

In an embodiment of a memory module of the present invention, a memory device with double the capacity and bit organization of other memory devices is used without mounting a memory device opposite the AMB device. Thus, the problem of different ball-out designs of the memory devices and the AMB device is solved.

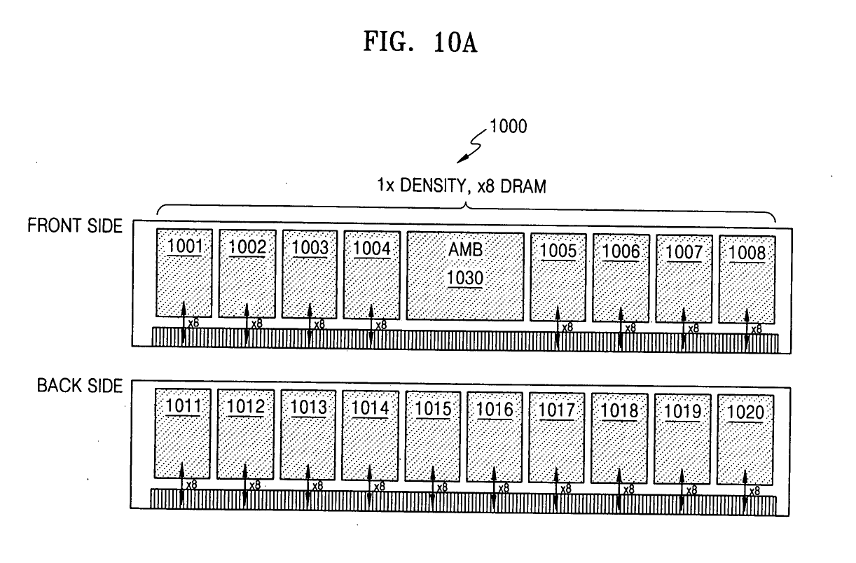

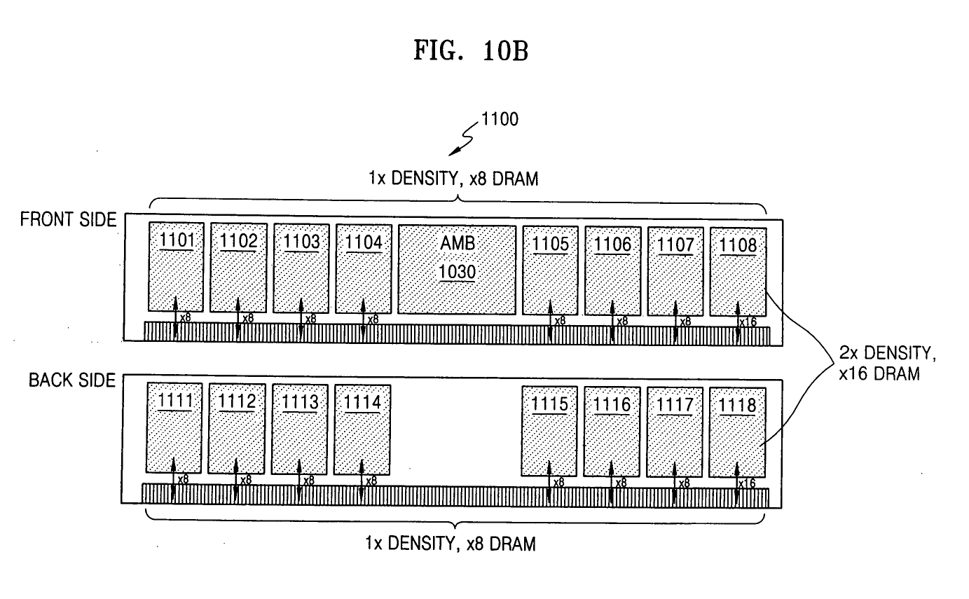

FIG. 10A illustrates a double rank ×8 AMB ECC memory module 1000 according to an embodiment of the present invention. A total of eighteen ×8 memory devices including sixteen ×8 memory devices for normal functions and two ×8 memory devices for providing the ECC function are used to form the double rank ×8 AMB ECC memory module 1000. The AMB ECC memory module 1000 includes eight ×8 memory devices 1001 through 1008 and an AMB buffer 1030 on the front side and ten ×8 memory devices 1011 through 1020 on the back side.

The AMB device 1030 is mounted on the front side of the memory module 1000, and the two memory devices 1015 and 1016 are mounted on the back side of the memory module opposite the AMB device 1030. Thus, the two memory devices 1015 and 1016 must have similar ball-out design as the AMB device 1030.

FIG. 10B illustrates a double rank ×8 AMB ECC memory module 1100 according to another embodiment of the present invention. The AMB ECC memory module 1100 includes seven ×8 bit memory devices 1101 through 1107, each of which has a density of 1×, an ×16 bit memory device 1108 with a density of 2×, and an AMB device 1130 between the memory devices 1104 and 1105 on the front side of the memory module 1100. The AMB ECC memory module 1100 also includes seven ×8 bit memory devices 1111 through 1117, each having a density of 1×, and a ×16 bit memory device 1118 with a density of 2× on the back side of the memory module 1100.

Unlike the AMB ECC memory module 1000 of FIG. 10A, no memory device is mounted opposite the AMB device 1130 on the AMB ECC memory module 1100 in FIG. 10B. Therefore, it is not necessary to design the ball-outs of the memory devices and the AMB device 1130 to be the same. Moreover, there is no need to design the ball-out of the AMB device 1130 in consideration of the ball-out of the memory devices.

Referring to FIG. 10B, the memory device 1108 functions as a ×8 memory device for forming a rank of the front side of the AMB ECC memory module 1100 and a ×8 memory device for storing parity bits for providing the ECC function. In addition, the memory device 1118 functions as a ×8 memory device for forming a rank of the back side of the AMB ECC memory module 1100 and a ×8 memory device for storing parity bits for providing the ECC function.

In another embodiment of the present invention, the memory device 1108 may function as two ×8 memory devices for forming the rank on the front side of the AMB ECC memory module 1100. In that case, one of the ×8 memory devices 1101 through 1107 may provide the ECC function. In addition, the memory device 1118 may function as two ×8 memory devices for forming the rank on the back side of the AMB ECC memory module 1100. In that case, one of the ×8 memory devices 1111 through 1117 may provide the ECC function.

A memory device with twice the capacity and bit organization of the other memory devices may be bigger than the other memory devices. Thus, such a bigger memory device may not be mounted to fit between smaller memory devices.

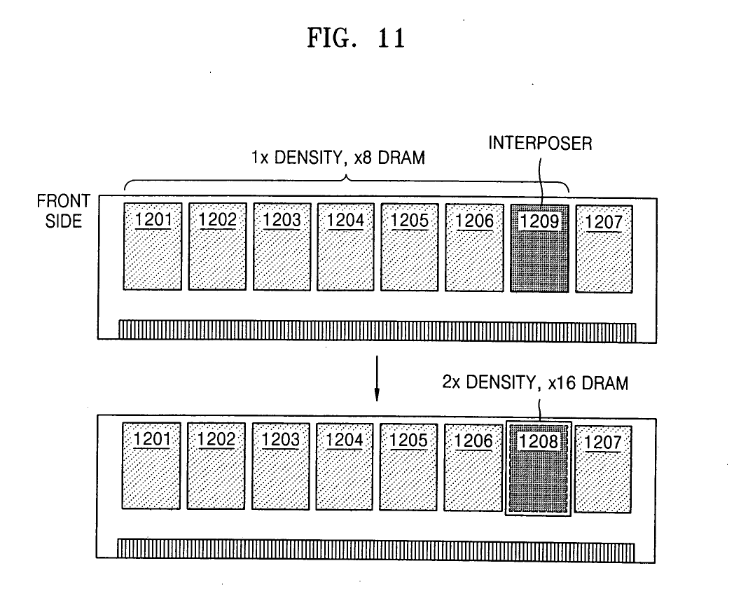

FIG. 11 illustrates an ECC memory module including a memory device of a different physical size from other memory devices according to an embodiment of the present invention. Referring to FIG. 11, seven ×8 bit memory devices 1201 through 1207, each with a density of 1×, and a ×16 bit memory device 1208 with a density of 2×, which is bigger than the memory devices 1201 through 1207, are mounted on the same side of the ECC memory module. To manufacture the ECC memory module, an interposer 1209 with the same size as the ×8 memory devices 1201 through 1207 is mounted on a portion of the ECC memory module where the ×16 memory device 1208 is to be mounted.

Then, the ×16 memory device 1208, which is bigger than the other memory devices 1201 through 1207, may be mounted on the interposer 1209. In this case, the interposer 129 is mounted higher than the memory devices 1201 through 1207. Thus, even if the ×16 memory device 1208 is bigger than the other memory devices 1201 through 1207, it may be mounted on the ECC memory module without taking up a larger area on the ECC memory module than the memory devices 1201 through 1207.

The ×16 bit memory device 1208 with a density twice those of the other memory devices 1201 through 1207 may function as a ×8 memory device for forming a rank and a ×8 memory device for providing the ECC function. In another embodiment, the ×16 memory device 1208 may function as two ×8 memory devices for forming the rank and one of the ×8 memory devices 1201 through 1207 may provide the ECC function.

The present invention can be used to solve the problem of increased loads of signal lines caused by an increase in the number of memory devices not only in an ECC memory module but also in all kinds of memory modules. At least one memory device with higher capacity and higher bit organization is used to provide an additional capacity portion for storing information for an additional function of the memory module aside from forming a rank.

The present invention has been described for the additional function being the ECC function. However, the present invention may be practiced for any other type of additional function of the memory module. For any such additional function, a memory module according to the present invention avoids decreased signal fidelity by preventing an increase in a package size, an increase in the load of signal lines, and asymmetric topology of signal lines.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A memory module comprising:
a first set of at least one first type of memory device; and
a second set of at least one second type of memory device having a higher capacity than the first type;
wherein an additional capacity portion of the first and second sets stores information for an additional function of the memory module;
and wherein a remaining capacity portion of the first and second sets forms a rank of the memory module.

2. The memory module of claim 1, wherein a total number of the memory devices in the first and second sets is an even number.

3. The memory module of claim 2, wherein a non-data signal line coupled to the memory devices of the first and second sets has a T-branch topology with equal numbers of the memory devices to each side of the T-branch.

4. The memory module of claim 1, wherein the memory devices of the first and second sets are all disposed on one side of the memory module with the remaining capacity portion of the first and second sets forming a single rank.

5. The memory module of claim 1, wherein the memory devices of the first and second sets are disposed on two sides of the memory module with the remaining capacity portion of the first and second sets forming double ranks.

6. The memory module of claim 1, wherein the memory devices of the first and second sets are disposed on two sides of the memory module with the remaining capacity portion of the first and second sets forming a single rank.

7. The memory module of claim 1, wherein the additional capacity portion is from only the second set.

8. The memory module of claim 1, wherein the additional capacity portion is from only the first set.

9. The memory module of claim 1, wherein the second type of memory device has twice a density of the first type of memory device.

10. The memory module of claim 9, wherein the second type of memory device has twice a bit organization of the first type of memory device.

11. The memory module of claim 1, wherein the first type of memory device and the second type of memory device have same address mapping.

12. The memory module of claim 1, further comprising:
a presence detector that stores information regarding different address mappings of the first and second types of memory devices.

13. The memory module of claim 1, further comprising:
an advanced memory buffer device disposed on a first side of the memory module, wherein no memory device is disposed on a second side of the memory module opposite the advanced memory buffer device.

14. The memory module of claim 1, further comprising:
a respective interposer disposed on the memory module for holding each of the second type of memory device.

15. The memory module of claim 1, wherein the additional capacity portion stores parity bits for an error-correcting code (ECC) algorithm.

16. A memory module comprising:
a first set of at least one first type of memory device;
a second set of at least one second type of memory device;
wherein an additional capacity portion of the first and second sets stores information for an additional function of the memory module; and
means for equalizing loads toward multiple directions of a non-data signal line.

17. The memory module of claim 16, wherein a total number of the memory devices in the first and second sets is an even number.

18. The memory module of claim 17, wherein the non-data signal line coupled to the memory devices of the first and second sets has a T-branch topology with equal numbers of the memory devices to each side of the T-branch.

19. The memory module of claim 16, wherein the additional capacity portion stores parity bits for an error-correcting code (ECC) algorithm.

20. A memory module comprising:
a first set of at least one first type of memory device;
a second set of at least one second type of memory device having a higher capacity than the first type of memory device; and
an advanced memory buffer device disposed on a first side of the memory module, wherein none of the memory devices of the first and second sets is disposed on a second side of the memory module opposite the advanced memory buffer device.
